(19) United States
(12) Patent Application Publication
(10) Pub. No.: US 2005/0038160 A1
(43) Pub. Date: Feb. 17, 2005

(54) Ethylene copolymers with hollow fillers

(76) Inventors: Matthew Scott Hall, Beaumont, TX (US); Stephen P. Musemeche, Orange, TX (US); George Wyatt Prejean, Orange, TX (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/874,769

(22) Filed: Jun. 23, 2004

Related U.S. Application Data
(60) Provisional application No. 60/495,622, filed on Aug. 15, 2003.

(51) Int. Cl. C08L 1/00

(52) U.S. Cl. 524/300

(57) ABSTRACT

Disclosed are filled and plasticized blends of (a) from about 10 to about 79% by weight of at least one copolymer derived from copolymerization of ethylene and at least one additional copolymer selected from the group consisting of vinyl esters of saturated carboxylic acids wherein the acid moiety has up to 4 carbon atoms, unsaturated mono- or dicarboxylic acids of from 3 to 5 carbon atoms, salts of said unsaturated acids and esters of said unsaturated mono- or dicarboxylic acids wherein the alcohol moieties forming said esters have from 1 to 6 carbon atoms; (b) from about 1 to 20 percent by weight of at least one plasticizer selected from the group consisting of processing oils, epoxidized oils, polyesters, polyethers, and polyether esters; (c) from about 20 to about 60% by weight of hollow filler; (d) from about 0.05 to about 5% by weight of at least one organic acid or acid derivative selected from the group consisting of dimer and trimer acids having from 36 to 60 carbon atoms, and mixtures thereof; and optionally (e) from 0 to about 5% by weight of tackifier. Also disclosed are sound management sheets that comprise these compositions. Also disclosed are carpets, especially automotive carpets, having backside coatings comprising these compositions; and construction panels comprising these compositions.

### CROSS-REFERENCE TO RELATED APPLICATIONS

Applicant claims the benefit of priority to provisional application 60/495,622 filed Aug. 15, 2003; herein incorporated by reference in its entirety.

### BACKGROUND OF THE INVENTION

1. Field of the Invention

This invention relates to blends of ethylene copolymers modified with organic acids and filled with hollow fillers such as glass or ceramic microspheres (e.g. cenospheres). When formed into sheets, the compositions help stop vibration that causes noise. Accordingly, this invention also relates to sound management sheets comprising these compositions. This invention also relates to carpets, especially automotive carpets, having backside coatings comprising the above compositions. This invention also relates to construction panels comprising the above compositions.

2. Description of the Related Art

Certain ethylene copolymers combined with inorganic fillers and modified with, for example, organic acids have been used for sound management purposes such as sound barriers or sound deadening. In general, there are three ways in which sound can be minimized or managed. The sound waves can be blocked, the vibrations can be damped, or the noise can be absorbed. To manage sound in these various ways, articles with different characteristics are required.

U.S. Pat. No. 6,319,969 discloses compositions of ethylene and/or α-olefin/vinyl or vinylidene interpolymers, particularly ethylene/styrene interpolymers, an organic acid and filler. The composition may also optionally contain an ethylene/vinyl acetate copolymer.

U.S. Pat. No. 4,434,258 discloses filled thermoplastic compositions obtained by blending from 0 to about 50% by weight of an ethylene interpolymer, such as ethylene/vinyl esters or ethylene/esters of unsaturated mono- or dicarboxylic acids; from 0 to 20% by weight of a plasticizer selected from the group consisting of processing oils, epoxidized oils, polyesters, polyethers, polyether esters and combinations thereof; from about 40 to about 90% by weight of filler; from about 0.05 to about 5.0% by weight of at least one organic acid or acid derivative selected from the group consisting of saturated polycarboxylic acids having from 6 to 54 carbon atoms, unsaturated mono- and dicarboxylic acids having from 12 to 20 carbon atoms, alicyclic and aromatic carboxylic acids, and mono-, di- and trivalent metal salts, esters and amides of said acids.

U.S. Pat. No. 4,430,468 discloses similar filled thermoplastic compositions obtained by blending from 0 to about 50% by weight of an ethylene interpolymer, such as ethylene/vinyl esters or ethylene/esters of unsaturated mono- or dicarboxylic acids; from 0 to 20% by weight of a plasticizer selected from the group consisting of processing oils, epoxidized oils, polyesters, polyethers, polyether esters and combinations thereof; from about 40 to about 90% by weight of filler; from about 0.05 to about 5.0% by weight of at least one surface active agent such as sulfonates, sulfates, phosphates, and optionally modifying resins, such as tackifiers and certain ethylene and propylene homo- and copolymers.

These patents also describe the above compositions in the form of sound-deadening sheets and carpets having a backside coating of the above compositions.

Conventional sound-deadening applications using filled copolymers typically use fillers such as calcium carbonate, barium sulfate and other inorganic salts that have relatively high density, leading to high-density compositions. It is desirable to develop sound-controlling materials that are lower in weight than conventional materials. Lower density sound-deadening materials are particularly useful in automotive and construction applications where the weight of products is of great importance.

Japanese Patent H03-57762 (JP 03057762) describes lightweight carpets prepared using glass microspheres in a copolymer matrix.

### BRIEF SUMMARY OF THE INVENTION

An object of this invention is to provide filled thermoplastic compositions with lower density (with specific gravity less than 1) than conventional filled thermoplastic compositions.

A further object of this invention is to provide filled thermoplastic compositions with higher heat resistance than conventional filled thermoplastic compositions.

Accordingly, this invention provides a filled thermoplastic composition consisting essentially of
(a) from about 10 to about 79% by weight of at least one copolymer derived from copolymerization of ethylene and at least one additional comonomer selected from the group consisting of vinyl esters of saturated carboxylic acids wherein the acid moiety has up to 4 carbon atoms, unsaturated mono- or dicarboxylic acids of from 3 to 5 carbon atoms, salts of said unsaturated acids and esters of said unsaturated mono- or dicarboxylic acids wherein the alcohol moieties forming said esters have from 1 to 6 carbon atoms;
(b) from about 20 to about 60% by weight of hollow filler;
(c) from about 1 to 20 percent by weight of at least one plasticizer selected from the group consisting of processing oils, epoxidized oils, polyesters, polyethers, and polyether esters;
(d) from about 0.05 to about 5% by weight of at least one organic acid or acid derivative selected from the group consisting of dimer and trimer acids having from 36 to 60 carbon atoms, and mixtures thereof; and optionally
(e) from 0 to about 5% by weight of tackifier.

As indicated above, these compositions are useful for sound management purposes. Accordingly, this invention also provides for a sound management (i.e. sound deadening) sheet comprising a composition as described above. This invention also provides for a carpet, especially an automotive carpet, having a backside coating comprising a composition as described above. This invention further provides for a construction panel comprising a composition as described above.

### DETAILED DESCRIPTION OF THE INVENTION

As used herein the term “consisting essentially of” means that the named ingredients are essential; however, other ingredients that do not prevent the advantages of the present invention from being realized can also be included.

All references disclosed herein are incorporated by reference.

“Copolymer” means a polymer containing two or more different monomers. The terms “dipolymer” and “terpolymer” mean polymers containing only two and three different monomers respectively. The phrase “copolymer of various monomers” and the like means a copolymer derived from the various monomers.

As used herein, the number of carbon atoms in a chemical moiety is designated by the notation Cₙ, in which n represents the number of carbon atoms present in said moiety.

Thermoplastic compositions are polymeric materials that can flow when heated under pressure. Melt index (MI) is the mass rate of flow of a polymer through a specified capillary under controlled conditions of temperature and pressure. Melt indices reported herein are determined according to ASTM 1238 at 190° C. using a 2160 g weight, with values of MI reported in grams/10 minutes.

Ethylene Copolymers

The ethylene copolymers suitable for the composition of the present invention are copolymers with at least one comonomer selected from the group consisting of vinyl esters of saturated carboxylic acids wherein the acid moiety has up to 4 carbon atoms, unsaturated mono- or dicarboxylic acids of from 3 to 5 carbon atoms, salts of said unsaturated acids and esters of said unsaturated mono- or dicarboxylic acids wherein the alcohol moieties forming said esters have from 1 to 6 carbon atoms. Terpolymers of ethylene and the above comonomers are also suitable. In addition, terpolymers of ethylene/vinyl acetate/carbon monoxide or ethylene/vinyl acetate/sulfur dioxide containing up to about 15 percent by weight of carbon monoxide or sulfur dioxide can also be employed.

The ethylene content of the copolymer is from about 40 to about 95% by weight, and the comonomer content is from about 5 to about 60% by weight. The preferred ethylene and comonomer level is from about 45 to about 91% and from about 9 to about 55% by weight, respectively. The most preferred ethylene and comonomer content is from about 88 to about 72% and from about 12 to about 28%, respectively. A mixture of two or more ethylene copolymers can be used in the blends of the present invention in place of a single copolymer as long as the average values for the comonomer content will be within the range indicated above.

Employing a copolymer containing over 28% nonethylenic comonomer (such as vinyl acetate) results in blends that are less stiff and have lower tensile strength, while their elongation is increased. The most preferred level is about 12 to 28 weight percent. Below 12% vinyl acetate, the blends become much stiffer, lose elongation, and oil compatability problems may arise. Even blends made with nonbleeding oils tend to become “oily” as polyethylene homopolymer is approached.

Melt index of the copolymer can range from about 0.1 to about 400, preferably from about 0.1 to about 50. Physical properties, principally elongation, decline to lower levels when the ethylene copolymer melt index is above about 50. Lower melt index ranges, from about 1 to about 10, are most preferred to maintain strength.

Copolymers of ethylene and a vinyl ester include copolymers such as ethylene/vinyl acetate (abbreviated EVA), ethylene/vinyl propionate and ethylene/vinyl butanoate.

Copolymers of ethylene and an unsaturated carboxylic acid, such as acrylic acid, methacrylic acid, or maleic acid, and optionally esters thereof as comonomers, that have some portion of the acidic groups in the copolymer neutralized with metal ions such as sodium or zinc are known as ionomeric resins or ionomers.

The term “ethylene/alkyl acrylate copolymers” includes copolymers of ethylene and alkyl acrylates wherein the alkyl moiety contains from one to six carbon atoms. Examples of alkyl acrylates include methyl acrylate, ethyl acrylate and butyl acrylate. “Ethylene/methyl acrylate (abbreviated EMA)” means a copolymer of ethylene (abbreviated E) and methyl acrylate (abbreviated MA). “Ethylene/ethyl acrylate (abbreviated EEA)” means a copolymer of ethylene (abbreviated E) and ethyl acrylate (abbreviated EA). “Ethylene/butyl acrylate (abbreviated EBA)” means a copolymer of ethylene (abbreviated E) and butyl acrylate (abbreviated BA).

In accordance with the above, suitable ethylene copolymers include copolymers such as ethylene/vinyl acetate, ethylene/acrylic acid and its ionomers, ethylene/methacrylic acid and its ionomers, ethylene/methyl acrylate, ethylene/ethyl acrylate, ethylene/isobutyl acrylate, ethylene/n-butyl acrylate, ethylene/isobutyl acrylate/methacrylic acid and its ionomers, ethylene/n-butyl acrylate/methacrylic acid and its ionomers, ethylene/isobutyl acrylate/acrylic acid and its ionomers, ethylene/n-butyl acrylate/acrylic acid and its ionomers, ethylene/methyl methacrylate, ethylene/vinyl acetate/methacrylic acid and its ionomers, ethylene/vinyl acetate/acrylic acid and its ionomers, ethylene/vinyl acetate/carbon monoxide, ethylene/methyl acrylate/carbon monoxide, ethylene/n-butyl acrylate/carbon monoxide, ethylene/isobutyl acrylate/carbon monoxide, ethylene/vinyl acetate/monoethyl maleate and ethylene/methyl acrylate/monoethyl maleate.

Preferred copolymers are ethylene/vinyl acetate, ethylene/methyl acrylate, ethylene/ethyl acrylate, ethylene/isobutyl acrylate, ethylene/methyl methacrylate, and ethylene/vinyl acetate/methacrylic acid. More preferred copolymers are ethylene/vinyl acetate and ethylene/methyl acrylate.

The relative amount of the alkyl acrylate comonomer incorporated into an ethylene/alkyl acrylate copolymer can, in principle, vary broadly from a few weight percent up to as high as 40 weight percent of the total copolymer or even higher. Similarly, the choice of the alkyl group can, again in principle, vary from a simple methyl group up to a six-carbon atom alkyl group with or without significant branching. The relative amount and choice of the alkyl group present in the alkyl acrylate ester comonomer can be viewed as establishing how and to what degree the resulting ethylene copolymer is to be viewed as a polar polymeric constituent in the thermoplastic composition.

Preferably, the alkyl group in the alkyl acrylate comonomer has from one to four carbon atoms and the alkyl acrylate comonomer has a concentration range of from 5 to 30 weight percent of the ethylene/alkyl acrylate copolymer, preferably from 10 to 25 weight %. Most preferably, the alkyl group in the alkyl acrylate comonomer is methyl.

Ethylene/alkyl acrylate copolymers can be prepared by processes well known in the polymer art using either autoclave or tubular reactors. The copolymerization can be run as a continuous process in an autoclave: ethylene, the alkyl acrylate, and optionally a solvent such as methanol (see U.S. Pat. No. 5,028,674) are fed continuously into a stirred autoclave of the type disclosed in U.S. Pat. No. 2,897,183, together with an initiator. The rate of addition will depend on variables such as the polymerization temperature, pressure, alkyl acrylate monomer employed, and concentration of the monomer in the reaction mixture needed to achieve the target composition of the copolymer. In some cases, it may be desirable to use a telogen such as propane, to control the molecular weight. The reaction mixture is continuously removed from the autoclave. After the reaction mixture leaves the reaction vessel, the copolymer is separated from the unreacted monomers and solvent (if solvent was used) by conventional means, e.g., vaporizing the nonpolymerized materials and solvent under reduced pressure and at an elevated temperature.

Tubular reactor produced ethylene/alkyl acrylate copolymer can be distinguished from the more conventional autoclave produced ethylene/alkyl acrylate as generally known in the art. Thus the term or phrase “tubular reactor produced” ethylene/alkyl acrylate copolymer, for purposes of this invention, denotes an ethylene copolymer produced at high pressure and elevated temperature in a tubular reactor or the like, wherein the inherent consequences of dissimilar reaction kinetics for the respective ethylene and alkyl acrylate comonomers is alleviated or partially compensated by the intentional introduction of the monomers along the reaction flow path within the tubular reactor. As generally recognized in the art, such a tubular reactor copolymerization technique will produce a copolymer having a greater relative degree of heterogeneity along the polymer backbone (a more random distribution of comonomers), will tend to reduce the presence of long chain branching and will produce a copolymer characterized by a higher melting point than one produced at the same comonomer ratio in a high pressure stirred autoclave reactor. Tubular reactor produced ethylene/alkyl acrylate copolymers are generally stiffer and more elastic than autoclave produced ethylene/alkyl acrylate copolymers.

Tubular reactor produced ethylene/alkyl acrylate copolymers of this nature are commercially available under the tradename Elvaloy® AC from E. I. du Pont de Nemours & Co., Wilmington, Del.

The actual manufacturing of the tubular reactor ethylene/alkyl acrylate copolymers as previously stated is preferably in a high pressure, tubular reactor at elevated temperature with additional introduction of reactant comonomer along the tube and not merely manufactured in a stirred high-temperature and high-pressure autoclave type reactor. However, it should be appreciated that similar ethylene/alkyl acrylate copolymeric material can be produced in a series of autoclave reactors wherein comonomer replacement is achieved by multiple zone introduction of reactant comonomer as taught in U.S. Pat. Nos. 3,350,372; 3,756,996; and 5,532,066, and as such these high melting point materials should be considered equivalent for purposes of this invention.

To further illustrate and characterize the tubular reactor produced ethylene/alkyl acrylate copolymer relative to conventional autoclave produced copolymer, the following list of commercially available ethylene/methyl acrylate copolymers with associated melting point data show that tubular EMA resins have considerably higher melting points vs. autoclave EMA's due to a very different MA distribution along polymer chains:

Autoclave Produced Copolymers

Exxon Mobil, N.J.; EMA (21.5 wt % MA) mp=76° C.

Exxon Mobil, N.J.; EMA (24 wt % MA) mp=69° C.

Atofina, France; EMA (20 wt % MA) mp=80° C.

Atofina, France; EMA (24 wt % MA) mp=73° C.

Tubular Reactor Produced Copolymers

Elvaloy® AC1125; DuPont; EMA (25 wt % MA) mp=88° C.

Elvaloy® AC1820; DuPont; EMA (20 wt % MA) mp=95° C.

For additional discussion regarding the differences between tubular reactor produced and autoclave produced ethylene/alkyl acrylate copolymers, see Richard T. Chou, Mimi Y. Keating and Lester J. Hughes, “High Flexibility EMA made from High Pressure Tubular Process”, Annual Technical Conference—Society of Plastics Engineers (2002), 60th (Vol. 2), 1832-1836. CODEN: ACPED4 ISSN:0272-5223; AN 2002:572809 CAPLUS.

Ethylene/alkyl acrylate copolymers suitable for use in this invention are available under the trademark Elvaloy® AC, available from DuPont. See Table A for specific examples of ethylene/alkyl acrylate copolymers available from DuPont.

TABLE A

| Ethylene/Alkyl Acrylate | | |
|---|---|---|
| Copolymer | Alkyl acrylate wt % | Melt Flow (g/10 min) |
| EMA | 25 | 0.4 |
| EMA | 25 | 0.6 |
| EMA | 9 | 2 |
| EMA | 14 | 2 |
| EMA | 18 | 2 |
| EMA | 24 | 2 |
| EMA | 9 | 6 |
| EMA | 20 | 8 |
| EMA | 13 | 9 |
| EEA | 12 | 1 |
| EEA | 16 | 1 |
| EEA | 15 | 6 |
| EEA | 15 | 7 |
| EBA | 7 | 1.1 |
| EBA | 7 | 1.1 |
| EBA | 17 | 1.5 |
| EBA | 17 | 1.8 |
| EBA | 27 | 4 |
| EBA | 17 | 7 |

The ethylene/alkyl acrylate copolymers useful in the present invention can vary significantly in molecular weight as witnessed by EMA having a melt index numerically in terms of a fraction up to about ten. The specific selection of the melt index grade of polymer component(s) to be used will be influenced by balancing the onset of improved elastic recovery associated with higher relative molecular weight copolymer (such as Elvaloy® AC1125 with a 0.7 MI) versus the pragmatic ability to more easily blend with fillers with a relatively lower molecular copolymer (such as Elvaloy® AC1820 with a 8 MI).

Generally from about 5 to about 50% by weight of ethylene/alkyl acrylate copolymer is employed in the composition of the present invention, preferably from about 8 to about 45% by weight, and most preferably from about 15 to about 40% by weight. Of course, compositions containing higher percentages of hollow filler will by necessity contain lower percentages of ethylene/alkyl acrylate copolymer. For example, compositions having 60 weight % of hollow filler will contain less than about 40 weight % ethylene/alkyl acrylate copolymer.

A mixture of two or more ethylene copolymers as described herein can be used in the blends of the present invention in place of a single copolymer as long as the average values for the comonomer content will be within the range indicated above. Particularly useful properties can be obtained when two properly selected ethylene copolymers are used in blends of the present invention. Of note is a composition of this invention wherein the ethylene/alkyl acrylate copolymer (i.e. an example of component (a)) comprises two different ethylene/methyl acrylate (EMA) copolymers. By combining two different properly selected EMA copolymer grades with filler, plasticizer, and an organic acid, modification of the physical properties of the filled composition can be achieved as compared with compositions containing only a single EMA resin grade. Most significantly, by replacing a single EMA grade in a filled blend with an equal amount of a properly selected mixture of two EMA grades, where the mixture has the same weight percent methyl acrylate content and melt index as the single EMA grade replaced, the tensile elongation can be increased substantially.

The actual manufacturing of tubular reactor produced EMA as previously stated is preferably in a high pressure, tubular reactor at elevated temperature with additional introduction of reactant comonomer along the tube and not merely manufactured in a stirred high-temperature and high-pressure autoclave type reactor. However, it should be appreciated that similar EMA material can be produced in a series of autoclave reactors wherein comonomer replacement is achieved by multiple zone introduction of reactant comonomer as taught in U.S. Pat. Nos. 3,350,372; 3,756,996; and 5,532,066, and as such these high melting point materials should be considered equivalent for purposes of this invention.

Hollow Filler

Any of a wide variety of hollow fillers may be used in the formulation of the present invention, including glass bubbles, mineral bubbles, and a manufactured multi-cellular bubble. Preferred hollow fillers are cenospheres. Cenospheres are somewhat irregularly shaped, glass-like hollow microspheres that are formed in boilers during the burning process of coal. They can be separated from coal power plant flyash. Flyash is composed primarily of SiO₂, Al₂O₃ and Fe₂O₃ (The composition is dependent on the source of the coal and its mineral content). The cenospheres usually comprise 5 to 30% by volume of flyash and can be separated from bulk flyash by a water separation method. The denser components of the flyash go to the bottom and the hollow spheres float. The spheres are then further separated by size (by sieving, for example). The cenospheres are significantly less dense than typical fillers comprising inorganic salts. For example, in an ethylene copolymer blend prepared according to this invention, forty-five weight percent (45 weight %) of cenospheres occupies the same volume as seventy-six weight percent (76 weight %) of calcium carbonate (CaCO₃) in the same polymeric matrix. This allows for the production of a filled composition with a specific gravity of about 0.9 versus about 1.9 for a typical CaCO₃ filled composition.

A particularly preferred type of cenosphere comprises the following chemical composition:

| | |
|---|---|
| Silica | 55% to 65% |
| Alumina | 25% to 35% |
| Iron Oxide | 1% to 5% |

These cenospheres have a particle size ranging from 5 to 300 microns and have the following particle size distribution (determined by sieving):

% passing 500 microns 100

% passing 300 microns 99.5-100

% passing 150 microns 50-90

% passing 100 microns 25-55

% passing 50 microns 5-10.

Cenospheres suitable for use in this invention as described above are supplied by Sphere Services Inc.

Cenospheres may also be prepared by spraying a sodium silicate/sodium nitrate-containing solution onto silica powder having an average particle size of 300μ. The resulting particles agglomerate and are extruded into granules, which are heated to between 700 and 800° C. in a rotary kiln. The heat decomposes the sodium nitrate to produce a gas that forms the beads into a foam-like structure that is maintained after drying, resulting in cenospheres. See PCT Patent Application Publication WO 01/79619 for additional details regarding this process.

Another suitable hollow filler is comprised of the cenospheres that are commercially available as Fillite^{(TM)} and are described in U.S. Pat. No. 3,782,985. Another suitable hollow filler is the siliceous spheres sold as Sphericell 110 P8. A fourth suitable filler is a glass bubble obtained from 3M called Scotchlite^{(TM)}. It is available in densities that range from approximately 10 lb/cu ft (0.15 g/cc) to 40 lb/cu ft (0.6 g/cc).

Plasticizers

The first group of plasticizer ingredients useful in the composition of the present invention is known as process or processing oil. Three types of processing oils are known: paraffinic, aromatic and naphthenic. None of these are pure; the grades identify the major oil type present.

Paraffinic oils tend to “bleed” from blends. Bleeding is normally not desirable, but could be useful in specialty applications, for example, in concrete forms where mold release characteristics are valued.

On the other hand, naphthenic acid and aromatic oils are nonbleeding when used in proper ratios and are thus preferable for uses such as automotive carpet backside.

Processing oils are also subdivided by viscosity range. “Thin” oils can be as low as 100-500 SUS (Saybolt Universal Seconds) at 100° F. (38° C.). “Heavy” oils can be as high as 6000 SUS at 100° F. (38° C.). Processing oils, especially naphthenic and aromatic oils with viscosity of from about 100 to 6000 SUS at 100° F. (38° C.) are preferred.

The amount of plasticizer, such as the processing oil, present in the composition of the present invention is from about 1 to about 20% by weight, preferably from about 2 to about 15% by weight.

In the selection of a processing oil, other factors such as the type of oil selected and its viscosity must be considered. These are discussed in detail in U.S. Pat. No. 4,191,798, incorporated herein by reference.

The second group of plasticizers that are useful in the practice of the present invention is the group comprising epoxidized oils such as epoxidized soybean oil and epoxidized linseed oil.

The third group of plasticizers that are useful are the polyesters, which, in general, are liquid condensation products of a polybasic acid and a polyol. The term “liquid” in the context of the present invention is used to mean pourable at room temperature. The acid component is most often a saturated aliphatic dibasic acid or an aromatic dibasic acid; adipic acid, azelaic acid, phthalic acid, sebacic acid, and glutaric acid, or mixtures thereof. The polyol can be an aliphatic polyol or a polyoxyalkylene polyol, such as ethylene glycol, propylene glycol, 1,4- and 1,3-butane glycol, diethylene glycol, and polyethylene glycol. Preferred polyester compositions would consist of an acid component of which greater than 50% by weight are aliphatic dibasic acids, and a polyol component of aliphatic polyol or even more preferably aliphatic glycol. Most preferred compositions are based on adipic or azelaic acid, and propylene glycol or 1,3- or 1,4-butane glycol. The molecular weight of these plasticizers can vary from a low of a few hundred up to a high of about 10,000. The molecular weight of commercial products is seldom specified. Typically in the trade, the molecular weight range of the product is classified as low, medium, or high. The preferred range of molecular weight for purposes of this invention is that classified as medium.

Mixtures of polyesters with hydrocarbon oils are also effective plasticizers in the present invention. One objective of using such a mixture is to couple the high efficiency of the relatively high cost polyester with the low cost of the hydrocarbon oil. The cost and performance of a compound plasticized with such a mixture can be improved significantly for a given application because properties can be tailored more precisely, or filler levels can be increased.

When used alone, the amount of polyester plasticizer in the composition of the present invention is from about 1 to about 15% by weight, preferably from about 2 to about 12% by weight.

Where a mixture of the polyester plasticizer and a hydrocarbon processing oil is employed, the relative proportions of the two components can be varied over a wide range depending upon performance objectives. Mixtures of plasticizers containing 50% or less of the polyester are preferred for economic reasons, and most preferred are those containing 20% or less of the polyester.

Polyethers and polyether esters are also useful as plasticizers in blends of the ethylene copolymers and fillers described above. In general, polyethers are oligomers or polymers of alkylene oxides; polymers of ethylene or propylene oxide are the most common types available commercially. Polyethers can be prepared by polymerization of aldehydes using various types of catalysts, or by acid or base catalyzed polymerization of an alkylene oxide, for example. Polyethers can be terminated by hydroxyl groups to form the diol (glycol) or, in the case of adducts of alkylene oxides with glycerol, for example, the triol, and so forth. The hydroxyl-terminated polyether can also be reacted with an acid to form the ester. Fatty acids such as lauric and stearic acids are commonly used; the most common examples of these compounds are the mono- and diesters of polyethylene or polypropylene glycol. The molecular weight of polyethers may range up to those typical of high polymers.

Preferred polyether compositions in the practice of this invention are those consisting of the polyols based on random and/or block copolymers of ethylene oxides and propylene oxides. The copolymer polyols provide better performance in terms of efficiency in compounds of the present invention containing very high levels of filler.

When used alone the amount of polyether plasticizer in the composition of the present invention is from about 1 to about 15% by weight, preferably from about 2 to about 12% by weight.

Mixtures of the polyether or the polyether ester plasticizers with either a polyester plasticizer or a hydrocarbon processing oil can also be used in the practice of this invention. The advantage of a polyether/polyester combination is the lower cost since the polyethers are cheaper than the polyesters. Combinations of polyether and processing oil are also cheaper because of the lower cost of the oil.

The relative proportions of the two components in a combination of polyether and polyester can be adjusted according to the efficiency of the system based on property requirements and cost. Those based primarily on polyester will not be as stiff and will be more expensive, for example, than those based primarily on a polyether or polyether ester.

Where a mixture of the polyether or polyether ester and hydrocarbon oil is employed, the relative proportions used will again depend upon cost and property requirements. Since polyethers are more expensive than processing oils, plasticizer mixtures containing no more than 50% polyethers are preferred.

As referred to above, a mixture of processing oil, on the one hand, and epoxidized oil, polyester or polyether or polyether ester, or any combination thereof, on the other hand, can also be used as the plasticizer for the compositions of the present invention.

Where a mixture of plasticizers is used, the amount of plasticizer may range from about 2 to about 15% by weight, preferably from about 4 to about 12% by weight.

Plasticizers comprising a processing oil are preferred.

Organic Acids

The final essential ingredient for the compositions of this invention is an organic acid of the proper type. So-called “dimer” and “trimer” acids (dimers and trimers of simpler straight-chain forms) having from 36 to 60 carbon atoms are highly effective in enhancing elongation and in increasing melt index, particularly at higher filler loadings. These dimer and trimer acids are derived from mono- or poly-unsaturated acids in which one or more of the olefinic bonds of a monomeric acid molecule reacts with one or more of the olefinic bonds of other monomeric acid molecules to form acyclic, cyclic, aromatic or polycyclic dimers and/or trimers. Typically a mixture of structures results, with cyclic addition products predominating. Of particular note are dimer acids (CAS Number 61788-894) and trimer acids (CAS Number 68937-90-6) derived from C₁₈ fatty acids such as linoleic acid. The unsaturated bonds remaining after dimerization or trimerization can be hydrogenated to provide fully saturated dimers (CAS Number 6878341-5) or fully saturated trimers. Dimer and trimer acids can be obtained from Arizona Chemical Company, Panama City, Fla. under the Unidyme® tradename.

Mixtures of the above-mentioned acids can be employed in compositions of this invention, as can mixtures of any of the acid types disclosed herein. Of particular note is a mixture of dimer and trimer acids, as described above, containing at least 51% and typically 55% trimer acids (measured by gas chromatography) obtained from Arizona Chemical Company, Panama City, Fla. as Unidyme® 60.

Mono-, di- and trivalent metal salts of these organic acids, in particular the calcium and zinc salts of fatty acids, are also effective in carrying out the purposes of this invention.

In using organic acids of the types described in the compositions of this invention the amount is from about 0.05 to about 5% by weight, and preferably from about 0.1 to about 2%. Most preferably, when using a dimer or trimer acid, the amount is from about 0.12% to about 0.65%.

Polymers, both homo- and copolymers, other than the ones referred to above, can also be used to some extent in combination with the above specified polymers without significantly interfering with the advantages obtained by the present invention. These include, but without limitation, polymers such as ethylene/carbon monoxide and ethylene/sulfur dioxide. Similarly other ingredients can also be added to the compositions of the present invention by a compounder in order to obtain some desired effect, such as reduction of cost, or enhancement of a physical property. Accordingly, extender resins, waxes, foaming agents, crosslinking agents, antioxidants, etc. that are widely used, particularly in hot melts, can be included in the compositions of the present invention. Illustrative examples of several special additives and of potentially desirable resin ingredients are given below.

The basic blends described above are essentially free of surface tack at ambient temperature. Even if made with a “bleeding” type of paraffinic oil, the final sheet, at ambient temperature, may be slippery to the touch but will not be tacky. (Of course, as temperatures are increased to the 200° F. to 250° F. level, the blends will be progressively softened and will adhere well to many substrates.) From time to time, compounders probably will want to produce sheeting with enhanced surface tack or adhesiveness. This can be done in the blends described in the present invention by incorporating a tackifier resin in the formulation. The tackifier may be any suitable tackifier known generally in the art such as those listed in U.S. Pat. No. 3,484,405. Such tackifiers include a variety of natural and synthetic resins and rosin materials. The resins that can be employed are liquid, semi-solid to solid, complex amorphous materials generally in the form of mixtures of organic compounds having no definite melting point and no tendency to crystallize. Such resins are insoluble in water and can be of vegetable or animal origin, or can be synthetic resins. The resins can provide substantial and improved tackiness of the composition. Suitable tackifiers include, but are not necessarily limited to the resins discussed below.

A class of resin components which can be employed as the tackifier composition hereof, are the coumarone-indene resins, such as the para-coumarone-indene resins. Generally the coumarone-indene resins that can be employed have a molecular weight that ranges from about 500 to about 5,000. Examples of resins of this type that are available commercially include those materials marketed as “Picco”-25 and “Picco”-100.

Another class of resins that can be employed as tackifiers useful in this invention is the terpene resins, including also styrenated terpenes. These terpene resins can have a molecular weight range from about 600 to 6,000. Typical commercially available resins of this type are marketed as “Piccolyte” S-100, as “Staybelite Ester” #10, which is a glycerol ester of hydrogenated rosin, and as “Wingtack” 95, which is a polyterpene resin.

A third class of resins that can be employed as the tackifier are the butadiene-styrene resins having a molecular weight ranging from about 500 to about 5,000. A typical commercial product of this type is marketed as “Buton” 100, a liquid butadiene-styrene copolymer resin having a molecular weight of about 2,500. A fourth class of resins that can be employed as the tackifier in this invention are the polybutadiene resins having a molecular weight ranging from about 500 to about 5,000. A commercially available product of this type is that marketed as “Buton” 150, a liquid polybutadiene resin having a molecular weight of about 2,000 to about 2,500.

A fifth class of resins that can be employed as the tackifier are the so-called hydrocarbon resins produced by catalytic polymerization of selected fractions obtained in the refining of petroleum, and having a molecular weight range of about 500 to about 5,000. Examples of such resin are those marketed as “Piccopale”-100, and as “Amoco” and “Velsicol” resins. Similarly, polybutenes obtained from the polymerization of isobutylene may be included as a tackifier.

The tackifier may also include rosin materials, low molecular weight styrene hard resins such as the material marketed as “Piccolastic” A-75, disproportionated pentaerythritol esters, and copolymers of aromatic and aliphatic monomer systems of the type marketed as “Velsicol” WX-1232. The rosin that may be employed in the present invention may be gum, wood or tall oil rosin but preferably is tall oil rosin. Also the rosin material may be modified rosin such as dimerized rosin, hydrogenated rosin, disproportionated rosin, or esters of rosin. Esters can be prepared by esterifying the rosin with polyhydric alcohols containing from 2 to 6 alcohol groups.

A more comprehensive listing of tackifiers, which can be employed in this invention, is provided in the TAPPI CA Report #55, February 1975, pages 13-20, inclusive, a publication of the Technical Association of the Pulp and Paper Industry, Atlanta, Ga., which lists well over 200 tackifier resins that are commercially available.

In use, the compounder generally will want to select an ethylene-based copolymer and a tackifier resin that will be mutually compatible; chemical similarities that will indicate compatibility can be used for guidance. For a few highly specialized uses, such as super-hot-tack, quick-stick blends, the compounder may well elect to use incompatible systems. Finally, the reverse effect may be sought—in such instances, where an unusually slippery surface is desirable, incorporation of small amounts of a slip aid such as Armid 0 may prove beneficial

In using tackifier resins, the amount used in compositions of this invention is from 0 to about 5% by weight of the blend.

The teachings above have dealt with several different potential polymeric ingredients on an “individual-ingredient” basis to outline contributions possible from widely varying resin or polymer types. It must be stressed that polymer ingredients of the above types can, of course, be mixed so that, for example, the compounder may elect to modify a simple four-component composition (i.e. ethylene copolymer/oil/filler/organic acid) by replacing part of the ethylene copolymer with a small amount of tackifier for adhesivity. In addition, part of the oil can be replaced with a polyester or polyether-type additive to attain highly effective plasticization with a lower total amount of plasticizer. Thus, the possible combinations and permutations available to a skilled compounder will be infinite, yet remain within the spirit and intent of this invention.

The blends of the present invention are thermoplastic in nature and therefore can be recycled after processing. The recycled material may also contain textile fibers, jute, etc. present in the trim obtained during production of the finished product (e.g., back-coated automotive carpet).

Preferred are compositions of this invention wherein component (a) comprises two different ethylene/methyl acrylate copolymers; the hollow filler of component (b) comprises cenospheres; the plasticizer of component (c) is a processing oil; and the organic acid of component (d) is selected from the group consisting of dimer and trimer acids, and mixtures thereof.

Compositions of this invention may comprise other optional additives such as conventional additives used in polymeric materials including, for example, carbon black, which is used as a coloring agent or filler; titanium dioxide, which is used as a whitening agent or filler; other pigments; dyes; optical brighteners; surfactants; stabilizers such as antioxidants, ultraviolet ray absorbers, and hydrolytic stabilizers; anti-static agents; fire-retardants; lubricants; reinforcing agents such as glass fiber and flakes; antiblock agents; release agents; processing aids; and/or mixtures thereof.

A commercially sized batch-type Banbury or equivalent intensive mixer is suitable for preparing the compositions of the present invention. A Farrel continuous mixer (“FCM”) is also a suitable mixing device. In either instance, dry ingredients are charged in routine fashion. It is convenient in most cases to inject the plasticizer component directly into the mixing chamber of either unit as per widely used practice with this type of equipment. When more than one plasticizer is used, and where any one of the plasticizers is present in a small amount (less than about 10 weight percent of the total plasticizer mixture), the plasticizers should be blended before addition to the other ingredients used in the filled compositions. This will facilitate uniform distribution of each plasticizer component in the final composition and thus ensure that optimum properties are obtained. Similarly, since the amounts of organic acid employed generally are so small (less than 1% for many cases), it is important to be certain that the organic acid is thoroughly mixed into the final blend. If this is not done, highly erratic values for physical properties may result. Thus, it may often prove helpful to premix the organic acid into a portion of one of the other ingredients, e.g., a liquid organic acid may be premixed with the process oil or a solid organic acid may be premixed with an aliquot of the filler. If desired, the copolymer and the plasticizer(s) can be precompounded as a “masterbatch” in a suitable intensive mixing device (e.g., Banbury mixer or screw extruder). This “masterbatch” can then be compounded with the filler and the other remaining ingredients to produce the final composition. A mix cycle of about 3 minutes is generally adequate for the Banbury mixer at an operating temperature ranging typically from about 325° F. to about 375° F. The operating rate for the FCM unit generally will fall within ranges predicted by literature prepared by the Farrel Company, Ansonia, Conn. Here, temperatures ranging typically from about 325° F. to about 425° F. are effective. In both cases, a very low plasticizer level, for example about 2 to 3%, may require higher temperatures, while plasticizer levels above about 7% may mix well at lower mixer temperatures. While not evaluated, it is expected that other devices for handling viscous mixes (MI of 0.1 to 20) should be entirely satisfactory.

Generally, changes in the sequence of addition of ingredients have not been found to be significant, provided that the final mixture is thoroughly fluxed to attain homogeneity.

Once blends are mixed, routine commercial practices may be used, such as underwater melt cutting plus drying or use of sheeting plus chopping methods, to produce a final composition in pellet form. Alternately, the hot mixture also may be immediately fabricated into a final form, e.g. sheeting, molding, etc.

The highly-filled compositions described herein may be processed industrially into final sheet, film or three-dimensional solid form by using standard fabricating methods well known to those skilled in the art. Thus, fabricating methods such as extrusion, calendering, injection or rotomolding, extrusion coating, sheet laminating, sheet thermoforming, etc. are all practical means for forming the compositions of this invention.

Sheet articles are typically extruded in one step and often subjected to thermoforming, such as for example described in U.S. Pat. No. 4,386,187, which is incorporated herein in its entirety by reference. Film articles can be prepared by extrusion and thermoforming, but also by casting or film blowing. Blown films require the copolymer by itself, or a relatively homogeneously mixed copolymer-polymer blend for the polymer component of the composition, which preferably is prepared in a separate step.

The blends of the present invention can readily be extruded onto a substrate, such as automotive carpet, foam, fabric or scrim material, or can be extruded or calendered as unsupported film or sheet. Depending upon the equipment used, and the compounding techniques employed, it is possible to extrude a wide range of film thickness, from below 20 mils to above 100 mils. Accordingly, this provides industry with an opportunity to vary the amount of sound deadening to be attained by varying film thickness, density of blends, ratio of filler load to binder, and similar techniques well known in the art.

As sound management articles, the highly filled compositions are useful in sound dampening components for automotive and other applications. The level of filler that these blends can bind without unacceptable degradation of the physical properties is significantly higher than many other polymers, particularly at higher temperatures.

The compositions of the present invention, when employed in sound barrier layer applications, are often used in conjunction with a decoupling layer of foam or fibrous felt. Use of a decoupling layer (in conjunction with said barrier layer) prevents the direct transmission of sound vibrations from the substrate through the barrier layer (which would occur if the sound barrier layer were directly affixed to the substrate). The sound barrier layer usually has a density of less than 1 g/cm³. The sound barrier composition of this invention can be calendered or extruded into a sheet prior to thermoforming to fit the contours of the vehicle, appliance or other structure to which it is applied. The barrier layer may then be laminated with the foam or fiber layer, and is often also layered with a carpet or other decorative layer. The substrate is the material of construction of the article for which sound management is required and typically comprises one or more materials selected from metal, plastic, glass, natural fibers, synthetic fibers, and wood.

Primary use for the compositions of the present invention will probably be in the sheeting field, particularly for low cost, lightweight, sound-deadening structures. Outstanding characteristics such as improved “hand”, “drape”, reduced stiffness, higher elongation, reduced weight, improved heat resistance and better thermal stability of the extruded sheeting result from the compositions of the present invention.

The filled thermoplastic compositions of this invention have many sound management uses including, but not limited to, extruded sheet to be used as a moldable sound barrier in sound deadening applications including transport systems such as automobiles, motorcycles, buses, tractors, trains, trams, airplanes, and the like. The sound-deadening sheet comprising a composition of this invention may be used in various ways:

When applied to automotive carpet, blends described are an effective and economic means to deaden sound, while also simultaneously serving as a moldable support for the carpet. The application of the compositions of the present invention in carpets, and particularly in automotive carpets, is essentially identical to methods already described in U.S. Pat. No. 4,191,798, the disclosure of which is hereby incorporated by reference.

When used in sheet form, especially when coated onto a fabric, the blends can be installed in other areas of an automobile, truck, bus, etc., such as side panels, door panels, roofing areas, headliners and dash insulators. The compositions of this invention may also be used in automotive door and truck liners, rear seat strainers, wheel well covers, carpet underlayments, dash mats, sound damped automotive enclosures such as oil pans, disc brake pads, mufflers, etc.

In sheet form, the filled blends may be used as drapes or hangings to shield or to surround a noisy piece of factory equipment such as a loom, a forging press, conveyor belts and material transfer systems, etc.

The compositions of this invention may be used for sound deadening in small and large appliances, including dishwashers, refrigerators, air conditioners, and the like; household items such as blender housings, power tools, vacuum cleaning machines, and the like; lawn and garden items such as leaf blowers, snow blowers, lawn mowers, and the like; small engines used in boating applications such as outboard motors, water-jet personal watercraft, and the like. Additional applications include devices for modifying the sound of a drum, loudspeaker systems, acoustically damped disc drive systems, and the like.

In construction and building industries, compositions of this invention may be used as wallpapers/coverings, composite sound walls, thermoformable acoustical mat compositions, vibration-damping constrained-layer constructions, and sound insulation moldable carpets. The blends may be used in construction panels, such as those that can be prepared and subsequently assembled to erect a structure such as a dwelling or storage facility. In laminated sheet form, the blends, faced with another material, can be used to achieve both a decorative and a functional use, such as dividing panels in an open-format office.

Preferred sound-deadening sheets and preferred carpets comprise the preferred compositions described above.

Other uses are possible. An advantage of the blends of this invention is that certain physical properties, such as flexibility and toughness, which are typically reduced when fillers are added to polymers, can be maintained within useful limits over a broad range of filler concentrations. As noted above, the improved heat resistance and better thermal stability afforded by the tubular reactor produced ethylene/alkyl acrylate copolymer is particularly advantageous. Thus, blends of this invention could be used in the manufacture of wire and cable components in a variety of electronic, telecommunications and similar areas, of various molded parts, of sealants and caulks, or in other uses where flexibility, toughness and heat resistance and better thermal stability are desired, coupled with the economies normally achieved by the incorporation of low cost fillers.

The following Examples are presented to more fully demonstrate and further illustrate various aspects and features of the present invention. As such, the showings are intended to further illustrate the differences and advantages of the present invention but are not meant to be unduly limiting.

### GENERAL PROCEDURES FOR EXAMPLES

The Examples that follow are given for the purpose of illustrating the present invention. All parts and percentages are by weight unless otherwise specified.

In all Examples, the ingredients were premixed in a one-gallon (about 3.8 I) can by shaking the contents manually for about 0.5 minutes. (Where liquid acids are employed, it is often preferably to premix the very small amount of acid into the much larger volume of liquid plasticizer, separately, before adding the liquid to the one-gallon can, to ensure reaching homogeneity rapidly). The ingredients were then added to a Banbury-type laboratory-sized intensive high-shear mixer. The materials were mixed for 3 minutes, at a temperature ranging from about 325° F. to about 375° F. (from about 160° C. to about 190° C.).

### Testing Criteria for Examples

Melt Index (MI) was measured in accord with ASTM D-1238, condition E, at 190° C., using a 2160-gram weight, with values of MI reported in grams/10 minutes. Density was determined in accord with ASTM D-792. DSC Melting point (m.p.) was determined in accord with ASTM D-3418. Vicat softening point was determined in accord with ASTM D-1525. Shore A hardness was determined in accord with ASTM D-2240. Ring and Ball Softening Point was determined in accord with ASTM E 28-67. Sound transmission properties were determined in accord with ASTM E90-02 and E413-87.

Without further elaboration, it is believed that one skilled in the art using the preceding description can utilize the present invention to its fullest extent. The following Examples are, therefore, to be construed as merely illustrative, and not limiting of the disclosure in any way whatsoever.

### EXAMPLES AND COMPARATIVE EXAMPLES

Materials Used

EVA-1: Ethylene/26% vinyl acetate having MI of 4, density of 950 kg/m³, melting point of 73° C. and Ring and Ball softening point of 132° C.

EMA-1: Ethylene/24% methyl acrylate having MI of 2.0, density of 944 kg/m³, melting point of 91° C. and Vicat softening point of 48° C.

EMA-2: Ethylene/20% methyl acrylate having MI of 8.0, density of 942 kg/m³, melting point of 92° C. and Vicat softening point of 54° C.

Dimer/Trimer Acid Blend, as described above, containing at least 51% and typically 55% trimer acids (measured by gas chromatography) available from Arizona Chemical Company, Panama City, Fla. as Unidyme® 60.

D3000 oil, a naphthenic processing oil having SUS Viscosity at 210° F.=128, Flash Point=510° F., Initial Boiling Point=830° F. and Ford Fog Value=80%, available from Ergon.

BLK CON, carbon black dispersed in polyethylene, used as a colorant, available under the tradename Polyone® 2447.

Cenospheres, as described above and supplied by Sphere Services Inc.

Amounts in Table 1 are reported in weight %.

TABLE 1

| Component | Ex. 1 | Ex. 2 |
|---|---|---|
| EVA-1 | 43.09 | 0 |
| EMA-1 | 0 | 29.03 |
| EMA-2 | 0 | 16.94 |
| Dimer/Trimer Acid Blend | 0.47 | 0.97 |
| D3000 oil | 11.58 | 6.45 |
| BLK CON | 0.67 | 0.65 |
| Cenospheres | 44.19 | 45.96 |

Comparative Example C1 is included to illustrate the properties of a typical commercially available filled thermoplastic composition. This is a 50% CaCO₃-filled ethylene/vinyl acetate blend.

EVA-2: Ethylene/28% vinyl acetate having MI of 6, density of 0.955 g/cm³, and Ring and Ball softening point of 154° C.

EVA-3: Ethylene/18% vinyl acetate having MI of 0.7, density of 0.94 g/cm³, and Ring and Ball softening point of 223° C.

Stearic Acid (octadecanoic acid), a monocarboxylic acid, CH₃(CH₂)₁₆COOH, molecular weight of 284.49, density 0.94 g/cm³, melting point of 70° C., commercial grade available under the trade name Industrene® B from Crompton Corporation.

CaCO₃, filler, molecular weight of 100.9, density 2.93 g/cm³, decomposition temperature of about 825° C., commercial grade.

TABLE 2
(Comparative Example C1)

| Component | Weight % |
|---|---|
| EVA-2 | 14.8 |
| EVA-3 | 3.5 |
| Stearic acid | 0.30 |
| BLK CON | 0.4 |
| CaCO₃ | 76.0 |

TABLE 3

| Property | Ex. 1 | Ex. 2 | Comp. Ex. C1 |
|---|---|---|---|
| Density (g/cc) | 0.935 | 0.935 | 1.90 |
| Mean break elongation (%) | 608 | 410 | 523 |
| Mean U.T. strength (%) | 541 | 219 | 288 |
| Yield strength (psi) | 541 | 200 | 271 |
| DSC m. p. (° C.) | 72 | 82 | 72 |
| Melt index | 2.69 | 1.66 | 3.34 |
| Shore A hardness | 87 | 84 | 88 |
| Flex modulus (psi) | 7407 | 6406 | 15519 |

Inspection of the properties summarized in Table 3 shows that the use of tubular reactor produced ethylene/alkyl acrylate provides filled compositions with high heat resistance (melting point above 80° C.).

Sound transmission class (STC) for Comparative Example 1 is 18, i.e., a film 35 mils thick provides 18 dB noise reduction.

Examples 1 and 2 provided an STC of 15, i.e., a film 35 mils thick provides 15 dB noise reduction.

When compared on a weight basis, the compositions of this invention filled with hollow filler are more effective at sound reduction than the more dense, conventional filled compositions. This is best illustrated by comparison of the sound transmission class of a composition divided by its density as shown in Table 3.

TABLE 3

| Example | Density (g/cc) | STC | STC/Density |
|---|---|---|---|
| 1 | 0.935 | 15 | 16 |
| 2 | 0.935 | 15 | 16 |
| C1 | 1.9 | 18 | 9.5 |

It can be seen that compositions of this invention are nearly twice as effective at sound reduction by weight than conventional high-density sound deadening compositions. This is particularly important where weight is a concern, such as in the automotive and construction industries. Having thus described and exemplified the invention with a certain degree of particularity, it should be appreciated that the following claims are not to be so limited but are to be afforded a scope commensurate with the wording of each element of the claim and equivalents thereof.

1. A filled thermoplastic composition consisting essentially of
(a) from about 10 to about 79% by weight of at least one copolymer derived from copolymerization of ethylene and at least one additional comonomer selected from the group consisting of vinyl esters of saturated carboxylic acids wherein the acid moiety has up to 4 carbon atoms, unsaturated mono- or dicarboxylic acids of from 3 to 5 carbon atoms, salts of said unsaturated acids and esters of said unsaturated mono- or dicarboxylic acids wherein the alcohol moieties forming said esters have from 1 to 6 carbon atoms;
(b) from about 20 to about 60% by weight of hollow filler;
(c) from about 1 to 20 percent by weight of at least one plasticizer selected from the group consisting of processing oils, epoxidized oils, polyesters, polyethers, and polyether esters;
(d) from about 0.05 to about 5% by weight of at least one organic acid or acid derivative selected from the group consisting of dimer and trimer acids having from 36 to 60 carbon atoms, and mixtures thereof; and optionally
(e) from 0 to about 5% by weight of tackifier.

2. The composition of claim 1 wherein component (a) contains at least one copolymer derived from copolymerization of ethylene and a vinyl ester of a saturated carboxylic acid.

3. The composition of claim 2 wherein component (a) contains at least one ethylene/vinyl acetate copolymer.

4. The composition of claim 1 wherein component (a) contains at least one copolymer derived from copolymerization of ethylene and an alkyl acrylate.

5. The composition of claim 4 wherein the alkyl group in said alkyl acrylate has from one to four carbon atoms.

6. The composition of claim 4 wherein said alkyl acrylate is produced in a tubular reactor.

7. The composition of claim 6 wherein said alkyl acrylate is methyl acrylate and is employed at a concentration range of from 20 to 30 weight percent of the total tubular reactor produced ethylene/methyl acrylate copolymer.

8. The composition of claim 7 wherein component (a) comprises two different ethylene/methyl acrylate copolymers.

9. The composition of claim 1 wherein said plasticizer comprises a processing oil.

10. The composition of claim 1 wherein component (a) comprises two different ethylene/methyl acrylate copolymers; the plasticizer of component (b) is a processing oil; the filler of component (c) comprises cenospheres.

11. A sound-deadening sheet comprising a composition of claim 1.

12. A carpet having a backside coating comprising a composition of claim 1.

13. A construction panel comprising a composition of claim 1.
